(19) United States
(12) Patent Application Publication
(10) Pub. No.: US 2022/0036016 A1
(43) Pub. Date: Feb. 3, 2022

(54) Systems and Methods of Card Reader Protection

(71) Applicant: International Technologies & Systems, Corporation, Cypress, CA (US)

(72) Inventors: Yi-fing Chen, New Taipei City (TW); Yu-ting Chang, Taoyuan City (TW)

(73) Assignee: International Technologies & Systems, Corporation, Cypress, CA (US)

(21) Appl. No.: 16/944,278

(22) Filed: Jul. 31, 2020

(51) Int. Cl. G06K 7/00; G06Q 20/34

(52) U.S. Cl. CPC G06K 7/0004; G06Q 20/34

(57) ABSTRACT

Example embodiments of the systems and methods of card reader protection disclosed herein combine motorization technology with payment card industry (PCI) protection technology. In an example embodiment, access to the card is protected by a mesh grid inside a printed circuit board (PCB). In one embodiment, there are five mesh grid walls in total. A secure signal is used to transmit data. The data is transmitted along traces embedded within the circuit boards. When a signal trace extends from one layer of the PCB to a second layer, the traces on the separate layers are connected with a via hole that extends between the layers and electrically connects traces on different layers. In an example embodiment, one or more of the boards fit together with slot joints. The vias are positioned in the board such that they are hidden due to the slot joint configuration.

### TECHNICAL FIELD

The present disclosure is generally related to transaction processing systems and, more particularly, is related to systems and methods of card reader protection.

### BACKGROUND

Payment card readers are designed to read information saved on a transaction card and securely communicate information (such as transaction data) to a requesting service, such as banks and credit card companies.

When, for example, a merchant swipes a transaction card, the transaction request is sent to a financial institution (such as a merchant bank or acquirer). The acquiring bank acts as an intermediary and sends the request to the issuing bank (the customer's credit card company). The issuing bank checks if the customer has enough money or credit for the charge. The issuing bank also uses fraud detection software to check if the transaction is legitimate. If approved, the transaction is authorized and a hold is put on the funds, which shows up as “pending.”

Magstripe readers and chip card readers function a bit differently in credit card transactions. On magstripe cards, the payment information is on a magnetic stripe and is static, such that the info stays the same every time the card is swiped. When a magnetic-stripe card is read, the bank info is transmitted to the card reader, which sends it to the acquiring bank.

EMV®, developed and managed by American Express, Discover, JCB, Mastercard, UnionPay, and Visa, is the global standard for chip cards. The data on chip cards is dynamically encrypted. Each EMV card has an embedded computer chip that stores cardholders' bank details. However, unlike magstripe cards, where the payment info is static, chip card data keeps changing, which makes it extremely difficult for potential hackers to extract anything useful. When a chip card is inserted into a chip card reader, the chip and reader communicate with each other with encrypted code. A new code is created for each transaction and the data is encrypted the moment the card is inserted. The encrypted data is then sent to the financial institution.

Both magstripe and EMV systems are susceptible to direct hardware hacking. Known protection designs, as disclosed in U.S. Pat. Nos. 6,853,093, 4,811,288, or TW I 387 403 are only applicable to the protection of small security modules. U.S. Pat. No. 4,811,288 uses ceramic sheets as the substrate for the protective wall. When the structure is large, the weight reduction of the unit and the drop resistance are greatly degraded. Although U.S. Pat. No. 6,853,093 and TW I387403 use PCB material as the protective wall for the protection circuit, when the size of the card reader is increased, the wasted material area is relatively increased, which is not conducive to the reduction of manufacturing cost. Therefore, there are heretofore unaddressed issues in the prior art.

### SUMMARY

Embodiments of the present disclosure provide systems and methods of card reader protection. Briefly described in architecture, one embodiment of the system, among others, can be implemented by a motorized card reader, the card reader configured to read information saved in at least one of a magnetic strip and an integrated circuit (IC) chip of a card inserted into the card reader; and a protection system comprised of a plurality of printed circuit boards (PCBs), at least two of the plurality of PCBs mechanically connected with slot joints, the at least two of the plurality of PCBs comprising multiple layers with maze-shaped serpentine circuit traces that comprise via-holes at the slot joint portion of the at least two of the plurality of PCBs.

Embodiments of the present disclosure can also be viewed as providing methods for card reader protection. In this regard, one embodiment of such a method, among others, can be broadly summarized by the following steps providing a motorized card reader, the card reader configured to read information saved in at least one of a magnetic strip and an integrated circuit (IC) chip of a card inserted into the card reader; and providing a protection system comprised of a plurality of printed circuit boards (PCBs), at least two of the plurality of PCBs mechanically connected with slot joints, the at least two of the plurality of PCBs comprising multiple layers with maze-shaped serpentine circuit traces that comprise via-holes at the slot joint portion of the at least two of the plurality of PCBs.

Other systems, methods, features, and advantages of the present disclosure will be or become apparent to one with skill in the art upon examination of the following drawings and detailed description. It is intended that all such additional systems, methods, features, and advantages be included within this description, be within the scope of the present disclosure, and be protected by the accompanying claims.

### BRIEF DESCRIPTION OF THE DRAWINGS

FIG. 1 is a block diagram of an example embodiment of an MCU with hardware security mechanisms.

FIG. 2 is a flow diagram of an example embodiment of a method of processing a transaction card with a motorized card reader.

FIG. 3 is a circuit diagram of an example embodiment of protection PCBs in a system of card reader protection.

FIG. 4 is a perspective diagram of an example embodiment of the protection PCBs of FIG. 3.

FIG. 5A is a perspective diagram of an example embodiment of two protection PCBs configured to connect with slot joints.

FIG. 5B is a perspective diagram of an example embodiment of the two protection PCBs of FIG. 5A that have been joined in a ninety degree angle with a slot joint.

FIG. 6A is a perspective diagram of an example embodiment of a rubberized conductor configured for connecting to ends of a switch in a protection circuit.

FIG. 6B is a perspective diagram of an example embodiment of a rubberized conductor configured for connecting to ends of a switch in a protection circuit.

FIG. 7 is a flow diagram of an example embodiment of a method of card reader protection.

FIG. 8 is a flow diagram of an example embodiment of a method of card reader protection.

FIG. 9 is a flow diagram of an example embodiment of a method of card reader protection.

FIG. 10 is a flow diagram of an example embodiment of a method of card reader protection.

### DETAILED DESCRIPTION

Embodiments of the present disclosure will be described more fully hereinafter with reference to the accompanying drawings in which like numerals represent like elements throughout the several figures, and in which example embodiments are shown. Embodiments of the claims may, however, be embodied in many different forms and should not be construed as limited to the embodiments set forth herein. The examples set forth herein are non-limiting examples and are merely examples among other possible examples.

The PCI compliant motorized card reader has been attempted in the industry for many years, but not successfully. An autoloading type automatic payment terminal needs to have its IC card reader/writer and PIN pad physically separated. It is technically difficult for the device to comply to the global security standard, PCI PTS. Currently PCI PTS certified machines are not available in the industry. The IC implementation should be done with “insertion type” (CCT direct or “non-retaining”).

In the current domestic infrastructure, technical issues including tamper resistance between the IC contact PIN entry and the IC reading point is hard to resolve within the environment (offline PIN operation) and is difficult to analyze or detect the internal structure of the card reader. In an offline PIN implementation, customer entry numbers are checked against the PIN in the IC chip on the card. In an online PIN implementation, the customer entry is checked against data on the issuer's system via a transaction network.

An automatic terminal includes an autoloading of the magnetic stripe transaction card and the IC chip transaction card. Card data verification is performed to prevent counterfeiting. The magnetic stripe card does not have card data verification, but the IC chip card performs a card data verification on a first level hardware EMV check and on a second level with a software EMV check. Identity verification is performed with both card types. The magnetic stripe card uses online PIN verification and the IC Card uses offline PIN verification.

In attempting to comply with the PCI PIN transaction security (PTS) requirements, the industry has not been able to meet a number of items, including revealing the insertion slot for the IC chip transaction cards, preventing access to the inside of the card reader through the card input slot, and erasing or destroying all stored data when the card reader is illegally opened. To prevent the insertion slot from being revealed when the contact IC chip card is inserted, a mechanism draws the card in and sends it into position in the reader without revealing the slot. To prevent access of the inside if the card reader through the card slot, a mechanism allows the slot to open while still preventing the clogging of the card reader. If the motorized card reader is illegally opened, the stored data should be erased, but not if the card reader slot is clogged.

An important PCI PTS requirement is core physical security. A removal prevention mechanism should prevent unauthorized access to remove/replace the motorized card reader and prevent the attachment of additional components. The industry has been unable to develop a solution to this issue because the autoloading mechanism needs to open the card reader input slot when the motorized card reader is clogged and the card reader then cannot be equipped with removal prevention/detection capabilities or an auto data erase function.

Another PCI PTS requirement is offline PIN security. The contact IC chip card insertion slot needs to be revealed so that a card holder can detect irregular interception of the card or suspicious objects to the motorized card reader. The industry has not been able to achieve compliance with the PCI PTS standard for an automatic card reader payment terminal because the wiring attached to the reader needs to be revealed to the card holder. In addressing these risks, the industry has not been able to develop a mechanism in device or in operation to respond to the risks of irregular interception or suspicious objects.

Yet another PCI PTS requirement is point of sale terminal integration security. Unauthorized removal of a card reader or retention of an inserted card needs to be prevented. An example of this is a “Lebanese Loop” in which a strip or sleeve of metal or plastic blocks the card reader input slot, causing any inserted card to be apparently retained by the machine, allowing it to be retrieved by a fraudster when the card holder leaves. Previous attempts by industry card readers have not been able to meet this PCI PTS requirement. The autoloading mechanism equips a card reader inside the motorized card reader system. When a card is clogged, the reader must be opened which causes the unit to be out of operation until maintenance can repair it.

The industry issues are numerous. Industry card reader manufacturers have attempted to solve the problems a number of ways. Card readers cannot be easily removed because the body of the automatic payment terminal firmly covers the reader. The card reader cannot be touched directly so irregular interception or placement of a suspicious object is not easy. The cover of the automatic payment terminal may be locked with a physical key. The card readers have been designed with components dedicated for automatic payment terminals to prevent unauthorized operations when the components are replaced with hardware that equips unauthorized functionality. Card readers have been equipped for detection of destruction of the device, detection of unauthorized open and shut, and detection of removal and/or replacement of the card reader. Sensors in the card reader detect insertion of suspicious objects into the card slot. Card insertion slots have a shutter to hide the slot, except when it is in use. The insertion slots accept transaction cards only and reject anything other than transaction cards.

Demonstrating that the industry has not been able to effectively secure the motorized card reader to PCI standards, card reader manufacturers have resorted to recommending external measures. These external measures include security cameras and attended monitoring stations to prevent destruction/removal of automatic payment terminals and to prevent irregular interception and placement of suspicious objects. During non-business hours, such as nighttime, facilities housing the devices are locked and protected by other crime prevention methods. Entry to the area is restricted. Open/shut access to the device should be in the office area.

Authentication with code numbers or an IC card may be required to enter/leave the room so an unauthorized entry is restricted. Entering or leaving the room may be monitored by security cameras. The key for the cover of the payment terminals may be stored in the appropriately managed security area, such as in a locked desk drawer or a safe. The key may be accessible only by limited staff and the usage may be recorded and monitored using a register book or any other methods which suppress inside crimes. Security labels, such as a label with serial numbers that is unrecoverable when peeled off, may be placed on the part where the device and the reader are joined so that any unauthorized open/shut operation may be detected upon inspection.

PCI standards require identity verification at an automatic payment terminal with an offline PIN using an external PIN pad because a signature check is not possible in operation. A transaction via an automatic payment terminal is a transaction without identity verification (PIN-less transaction) according to the guideline for signatureless transactions. An automatic payment terminal processes transactions without identity verification (PIN-less transactions). So the transaction without identity verification is allowed if the payment amount is within certain limits. Transactions with high cashability such as electronic money chargers may be excluded. Even though PIN pads are mandatory, a payment terminal without PIN pad may be allowed as long as it complies with the following conditions, also depending on the environment and characteristics of the device: (1) only handles transactions that the payment amount is within a CVM limit; (2) PIN entry is virtually impossible due to the environment (for example, the terminal is located at a highway tollgate); (3) the cardholder is seated in the car and leaning out of the window is difficult and dangerous; (4) PIN entry has risk to be monitored and stolen by people around the cardholder. Current card readers have not been able to meet the PCI standards.

Example embodiments of the systems and methods of card reader protection disclosed herein combine motorization technology with payment card industry (PCI) protection technology to solve the aforementioned problems with current industry devices. In an example embodiment, access to the card is protected by a mesh grid inside a printed circuit board (PCB). In an example embodiment, there are five mesh grid walls in total. A secure signal is used to transmit data. The data is transmitted along traces embedded within the circuit boards. When a signal trace extends from one layer of the PCB to a second layer, the traces on the separate layers are connected with a via hole that extends between the layers and electrically connects traces on different layers. The via holes are possible points of access for hackers. In an example embodiment of the systems and methods of card reader protection disclosed herein, the hole for the secure signal is hidden in two boards where the fitting overlaps. In an example embodiment, one or more of the boards fit together with slot joints. The vias are positioned in the board such that they are hidden due to the slot joint configuration.

Example embodiments of the systems and methods of card reader protection disclosed herein provide a motorized card reader with a credit card industry (PCI) protection design and a PIN function. The protective circuit wall of a secure zone may be split into several pieces of PCBs. This can save waste in PCB manufacturing. When the protection circuit PCBs are assembled with each other, they are designed in a slot joint configuration. In an example embodiment, maze-shaped serpentine circuits in the protection circuit wall change layers in the PCB, and the via holes may be hidden in the overlapped area of the slots of the adjacent protection circuit PCB. Mutual protection can increase the protection level of the secure zone.

An example embodiment of the systems and methods disclosed herein includes a frame, a read head for reading a magnetic stripe signal of a financial card or a credit card, an IC reader (for example, a spring type connector) for reading an IC chip signal of a financial card or a credit card, and a motor driving mechanism for transporting the card. The read head for reading the magnetic strip signal may be positioned in the path of the magnetic strip on the corresponding card as it is received by the motorized card reader, and can read the signal of any single track on the magnetic strip or the signals of all three tracks. The position of the magnetic strip and the content format may be defined by international standard ISO 7811. If the card is in accordance with Japanese Industrial Standard JIS X 6302-2, a second magnetic strip may be positioned on the back side of the standard magnetic strip position of the card and may be read by a second read head. The spring type connector to read the IC chip may be mounted to read a corresponding chip contact point on the card, and its position is as described in the international standard ISO 7816.

In an example embodiment, the motor drive mechanism includes a DC motor, a gear reduction mechanism, and a pair of rubber rollers that contact the card. The gear reduction mechanism may include a pair of gears and belts configured to drive a driving side rubber roller and a tension rubber roller on an opposing side. When a card is inserted between the pair of rubber rollers, the tension side roller provides sufficient positive pressure on the card to enable the capture of the card. Then the driving side roller is able to transport the card by friction. A plurality of optical sensors may be mounted on a main PCB and a sub PCB to detect the position of the card in the frame, so that the motor drive mechanism can correctly transport the card without losing the position of the card and causing malfunction. This will also prevent the insertion of a second card in the frame when a first card is already in the frame, avoiding damage to the internal mechanism. In an example embodiment, a detection mechanism is positioned at the front end of the card reader for preventing foreign matter from entering. When the width of an attempted insert is smaller than a standard card width, the gate will not open for prevention of damage to the card reader.

In an example embodiment of the systems and methods of card reader protection, five protection circuit PCBs provide PCI protection for a main PCB and a sub PCB. The main PCB provides payment processing functionality and the sub PCB provides motor control functionality in a non-limiting example implementation. The main PCB and sub PCB are provided in parallel planes. In an example implementation, a first protection circuit PCB is mounted on the main PCB and the second protection circuit PCB is mounted on the sub PCB. The first and second protection circuit PCBs protect an attack from a hacker on the card slot side but do not affect the card insertion and delivery. The third, fourth, and fifth protection circuit PCBs are mounted on the other three sides. In an example embodiment, protective circuits, such as those embedded in the protection PCBs, are also arranged inside the main PCB and the sub PCB. In an example implementation, the six sides of a rectangular-shaped card reader are protected by the protection circuit PCBs.

In an example embodiment, a protection circuit includes a maze-like serpentine conductor circuit with many loops, with both ends of the conductor circuit connected to a microcontroller with a safety detection mechanism, such as the K81 series MK81FN256VDC15 produced by NXP. When there is damage in the middle of the conductor circuit, such as, for example, if the circuit is broken or if the protection circuits of different loops are short-circuited, or the protection circuit is short-circuited with any power line or ground line, the microcontroller may detect an abnormal attack and immediately destroy the data that has been read from the card and stored in secure static memory of the card reader. Then the card reader will be in a disabled state and a hacker cannot obtain any key information used for security encryption.

In addition to the first, second, and fifth protection circuit PCBs, one or more rubber conductors may be placed on the inner side of each of the individually removable PCBs. When the individual PCBs are mounted in position, the rubber conductors are compressed and connect the protection circuit between adjacent PCBs such that a continuous circuit is formed. If a hacker opens the PCB such that the rubber conductor will not be able to maintain the circuit line continuity, the microcontroller detects an abnormal attack and data protection measures are enacted.

In a typical PCB, the PCB comprises at least four layers of laminates. At least two layers of protection circuit are encased between two outer layers of protection laminate. In an example embodiment of the systems and methods of card reader protection disclosed herein, a protection circuit includes a maze-like serpentine conductor circuit. The adjacent trace signals comprise different circuit protection circuits, power line, or ground line. In an example embodiment, the protection circuits between the different boards are connected in series. The circuit traces travel to inner surface layers to be connected to another PCB by solder joints or flexible circuit boards. The circuit traces change layers when the protection lines go to the inner surface.

To connect traces between layers in a typical multiple layer PCB, via holes are drilled and plated to form a conducting path. In previous designs, in order to avoid the security weakness of the via hole being used by the hacker, a semi-buried hole design was used in which the outer surface layers cover the via holes that connect the traces between the inner layers. However, this method increases the manufacturing cost of the PCB as there are two wasted layers. In example embodiments of the disclosed systems and methods of card reader protection, the adjacent PCB is electrically connected by the structure of a slot joint, and the position of the drilling holes can be placed in the slot areas at the position where the two PCBs meet so that the via holes on the PCB can be protected through the adjacent PCB. The through hole in the PCB does not degrade the strength of the protection, and the manufacturing cost may be reduced.

The main PCB and sub PCB cannot be combined with the slot joint structure for easy assembly and subsequent possible maintenance because they lie in parallel planes. In an example implementation, the main PCB and sub PCB are connected via a flex cable. Therefore, the assembled height of the main PCB and sub PCB is lower than the surrounding protection circuit PCB. This prevents a hacker from using a needle probe to attack the switch at the rubber conductor by the gap between PCBs. The main PCB cannot be opened and the data signal cannot be hacked.

In an example embodiment of the systems and methods of card reader protection disclosed herein, a protection circuit PCB is used as protection on the top, bottom, left, right, front and rear sides of the motorized card reader to protect, for example, the magnetic strip signal, the IC chip signal, the encryption keys stored in the MCU, and the firmware that runs the card reader. A rubber conductor may be configured to connect adjacent PCBs to detect the removal of the PCBs themselves.

In an example embodiment, the adjacent protection circuit PCBs are combined in a slot joint configuration. The positions of the via holes for secure signals are placed at the slot joints such that the adjacent protection circuit PCBs can protect the via holes of adjacent boards.

In a typical motorized card reader, sensors determine the position of the card, and the mounting position of the sensor is arbitrarily placed under the limitation of the mechanism space of the reader. However, for example, when a transparent card or a translucent card is inserted into the card reader, the moving position of the card cannot be correctly interpreted, so that the complete card transaction process cannot be effectively completed. In an example embodiment of the systems and methods of card reader protection disclosed herein, the position of the sensor is placed in the path of the magnetic strip on the card. The opaque material of the card allows for accurate sensing by the sensors positioned under the strip, providing effective operation of the card reader. The position of the sensor is placed on the path through which the magnetic strip passes on the card. The sensors may be active or passive, and may be of many types, including optical, infrared, proximity, ultrasonic, and magnetic sensors as non-limiting examples.

A typical motorized card reader has one card insertion and one card withdrawal in the process of one card transaction. The card must reach the correct position to read the data of the magnetic stripe on the card or the data on the IC chip of the card when the card is inserted. Sudden steep movement, impact, or severe speed change, for example, may cause malfunctions in the reading of the magnetic data. If the IC chip reading structure is involved in the process of reading magnetic strip data, magnetic strip data reading may fail. The IC chip reader causes a deceleration of the transaction card. The deceleration may cause errors in reading the data from the magnetic stripe. So, first, the magnetic stripe is read, and then the IC chip is read. In an example embodiment of the systems and methods of card reader protection disclosed herein, the operation of reading the magnetic strip data and the IC chip data on the card is divided into two stages. In the first stage, only the magnetic stripe data is read in the first card insertion operation; in the second stage, the card is first moved away and repositioned. After the repositioning, the data of the IC chip can be read. When reading the magnetic stripe data, all external force factors are reduced to a minimum, so that the success rate of reading data may be increased.

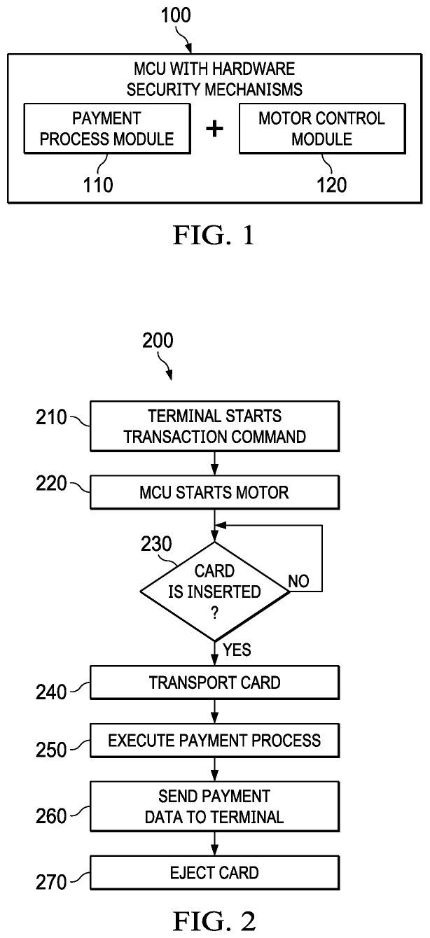

FIG. 1 provides a block diagram of microcontroller unit (MCU) 100 configured for processing hardware security mechanisms. MCU 100 includes payment processing module 110 and motor control module 120. Motor control module 120 senses when a card is inserted into the card reader and pulls the card into the card reader. The card reader reads the data from the card and processes a transaction with payment processing module 110.

FIG. 2 provides flow diagram 200 of an example embodiment of a method of processing a card with a motorized card reader. In block 210, a terminal housing the motorized card reader starts a transaction command. The terminal is a host to control the motorized card reader. The host sends a command to the card reader to start an action, such as drawing a transaction card into the reader or ejecting the transaction card out of the reader. In block 220, the MCU starts the motor for receiving the transaction card. In block 230, a determination is made as to whether a card has been inserted. If a card has not been inserted, block 230 is repeated. If a card has been inserted, in block 240, the card is transported into the card reading position. In block 250, the payment process is executed. In example embodiments, this includes reading the data from the magnetic strip and/or the IC chip on the card. In block 260, payment data is sent to the terminal. In block 270, the card is ejected.

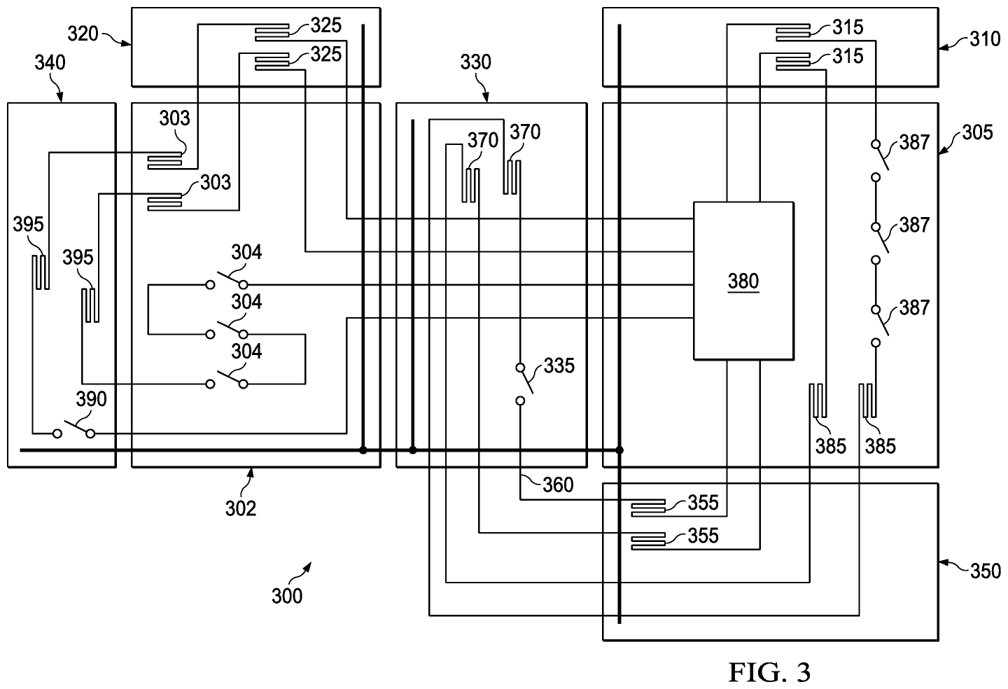

FIG. 3 provides circuit diagram 300 of an example embodiment of a system of card reader protection. Main PCB 305 includes MCU 380, security detection loops 385 and switches 387. Sub PCB 302 includes security detection loops 303 and switches 304. First protection PCB 310 includes security detection loops 315. Second protection PCB 320 includes security detection loops 325. Third protection PCB 330 includes security detection loops 370 and switch 335. Fourth protection PCB 340 includes security detection loops 395 and switch 390. Fifth protection PCB 350 includes security detection loops 355. The security detection loops (385, 303, 315, 325, 370, 395, and 355) provide hardware protection for the card reader. Main PCB 305 and sub PCB 302 are assembled in parallel planes and the motorization, optical sensors and read heads, for example, are positioned, attached to one of main PCB 305 and sub PCB 302. The protection PCBs (310, 320, 330, 340, and 350) are assembled around main PCB 305 and sub PCB 302.

First protection PCB 310 is mounted to main PCB 305 and second protection PCB 320 is mounted to sub PCB 302. First protection PCB 310 and second protection PCB 320 protect an attack from a hacker at the point of the card input slot but do not affect the card insertion or delivery. Third protection PCB 330, fourth protection PCB 340 and fifth protection PCB 350 are mounted on the other three sides. Protection circuits 385, 303, 315, 325, 395, 355, and 370 form a maze-like serpentine conductor circuit with many loops and with both ends connected to MCU 380, which performs safety detection. If there is damage to the conductor circuit (circuit is broken, loops are short circuited, or the protection circuit is shorted to power or ground as non-limiting examples) MCU 380 detects the fault condition and may be configured to destroy any data saved in static memory. This condition will place the card reader in a disabled state.

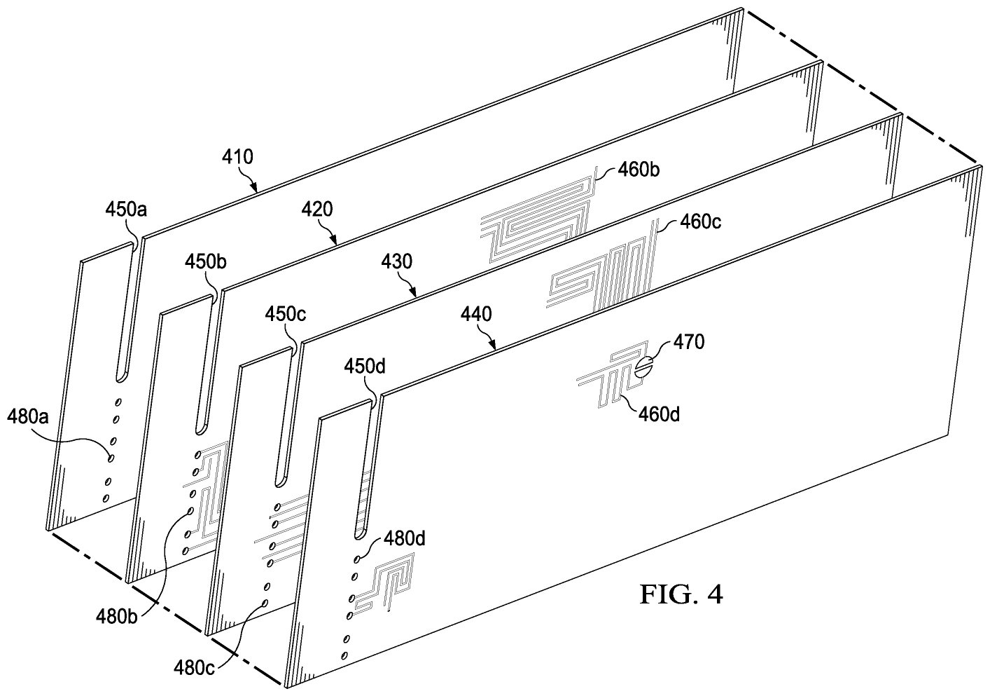

FIG. 4 provides a perspective diagram of protection PCBs 410, 420, 430, and 440 before they are mounted around the main PCB and the sub PCB. Each of protection PCBs 420, 430, 440 has a protection circuit (for example, 460b, 460c, 460d). Each protection circuit may include open switches in them (for example, switch 470). In an example embodiment, each of protection PCB 410, 420, 430, 440 comprises slots 450a, 450b, 450c, and 450d respectively. Slots 450a, 450b, 450c, and 450d are used to connect the protection PCBs together. Via holes 480a, 480b, 480c, and 480d provide pass through connections for traces on different layers and are positioned under slots 450a, 450b, 450c, and 450d such that when slots 450a, 450b, 450c, and 450d are joined, the adjacent board effectively hides via holes 480a, 480b, 480c, and 480d and prevents direct hacking of the signals passing through via holes 480a, 480b, 480c, and 480d. In an example embodiment, open switch 470 is closed using a rubber conductor. When, for example, protection PCB 440 is in operational placement, the rubberized conductor is compressed, making protection circuit 460d continuous.

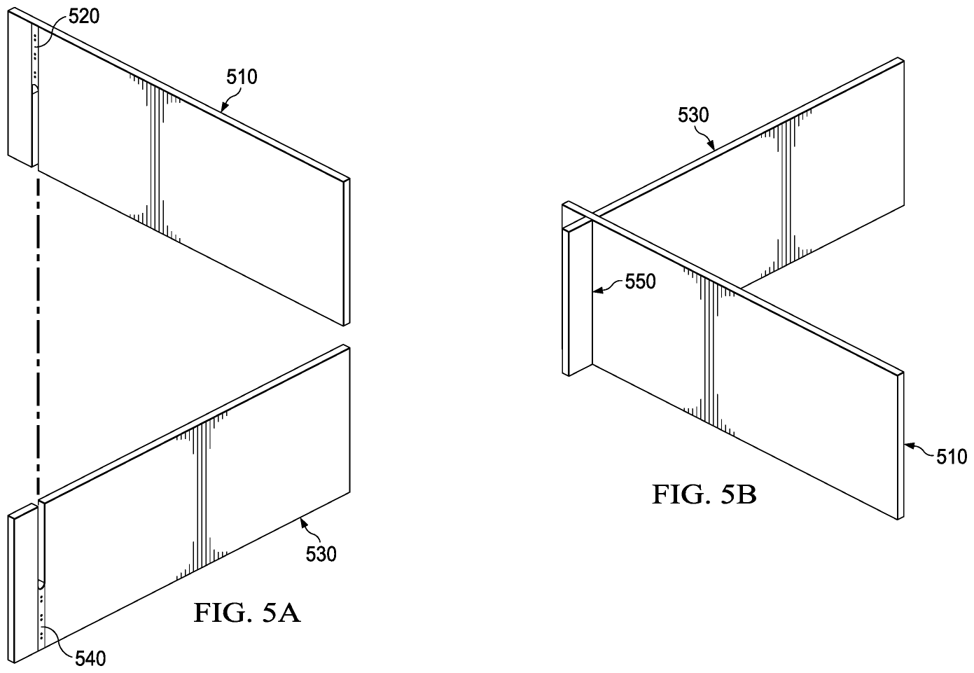

FIG. 5A and FIG. 5B provide perspective diagrams of two protection PCBs 510, 530 for connection in a slot joint configuration. In FIG. 5A protection PCB 510 is provided with the slot opening at the bottom of the board and via holes 520 in line with the slot in the top half of the board. Protection PCB 530 is provided with the slot opening at the top of the board and via holes 540 in line with the slot in the bottom half of the board. In FIG. 5B, protection PCBs 510 and 530 are joined at a right angle by connecting the slots to form slot joint 550. Slot joint 550 effectively hides via holes 520 and 540 of FIG. 5A.

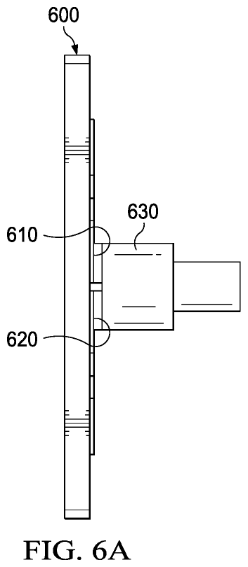

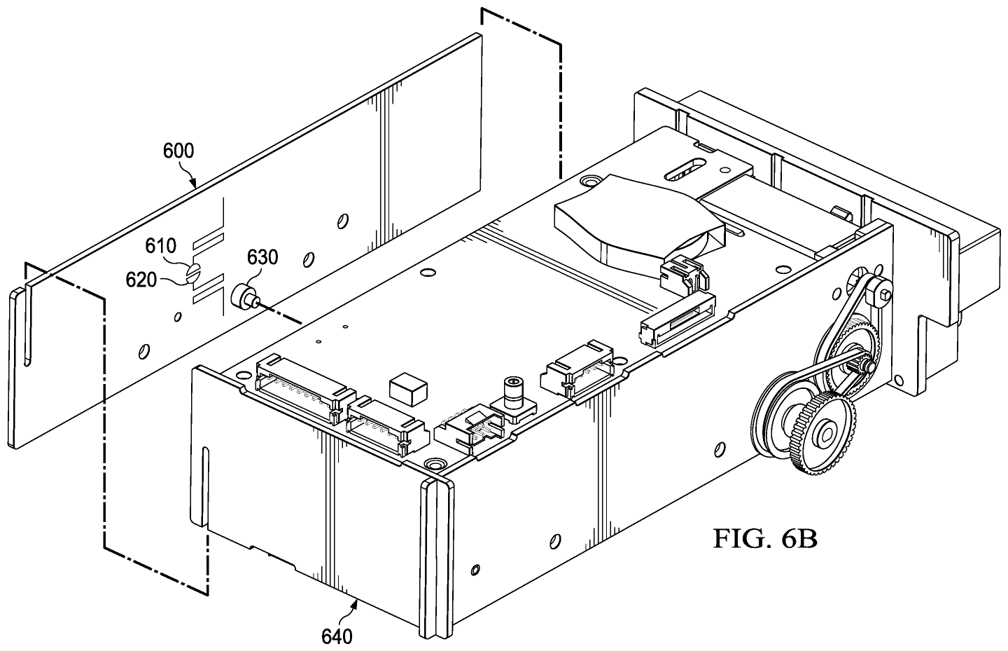

FIG. 6A provides a perspective diagram of protection PCB 600 with rubber conductor 630 in place to connect ends 610 and 620 of an open switch in a protection circuit on protection PCB 600. When rubber conductor 630 is in place, the switch is effectively closed and no fault condition occurs. However, if protection PCB 600 is moved such that rubber conductor 630 no longer closes the switch, a fault condition occurs and is noted by the security MCU.

FIG. 6B provides a perspective diagram of protection PCB 600 in position for placement against the main PCB. In an example embodiment, rubber conductor 630 is placed to connect ends 610 and 620 of an open switch in a protection circuit on protection PCB 600. When rubber conductor 630 is in place, the switch is effectively closed and no fault condition occurs. However, if protection PCB 600 is moved such that rubber conductor 630 no longer closes the switch, a fault condition occurs and is noted by the security MCU.

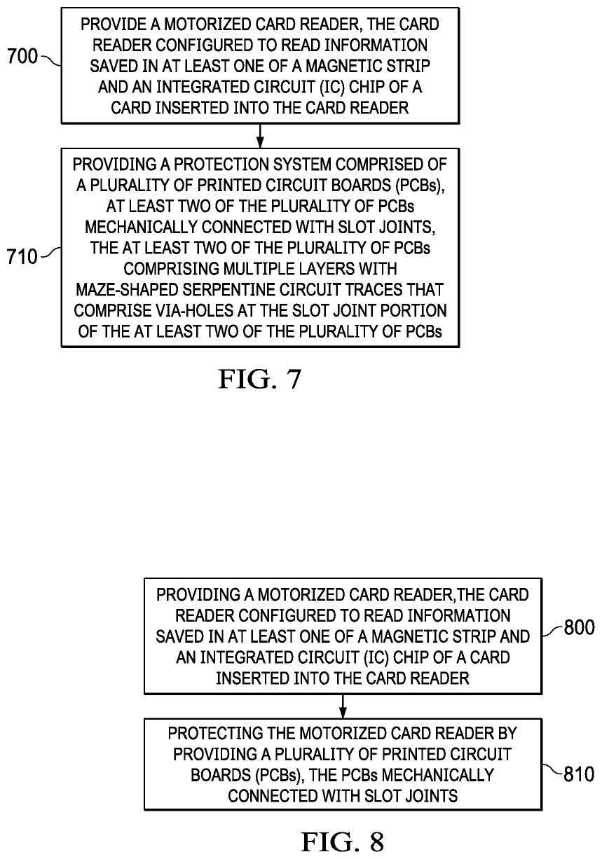

FIG. 7 provides a flow diagram of an example embodiment of a method of card reader protection. In block 700, a motorized card reader is provided, the card reader configured to read information saved in at least one of a magnetic strip and an integrated circuit (IC) chip of a card inserted into the card reader. In block 710, a protection system is provided, the protection system comprising a plurality of printed circuit boards (PCBs), at least two of the plurality of PCBs mechanically connected with slot joints, the at least two of the plurality of PCBs comprising multiple layers with maze-shaped serpentine circuit traces that comprise via-holes at the slot joint portion of the at least two of the plurality of PCBs.

FIG. 8 provides a flow diagram of an example embodiment of a method of card reader protection. In block 800, a motorized card reader is provided, the card reader configured to read information saved in at least one of a magnetic strip and an integrated circuit (IC) chip of a card inserted into the card reader. In block 810, the motorized card reader is protected by providing a plurality of printed circuit boards (PCBs), the PCBs mechanically connected with slot joints

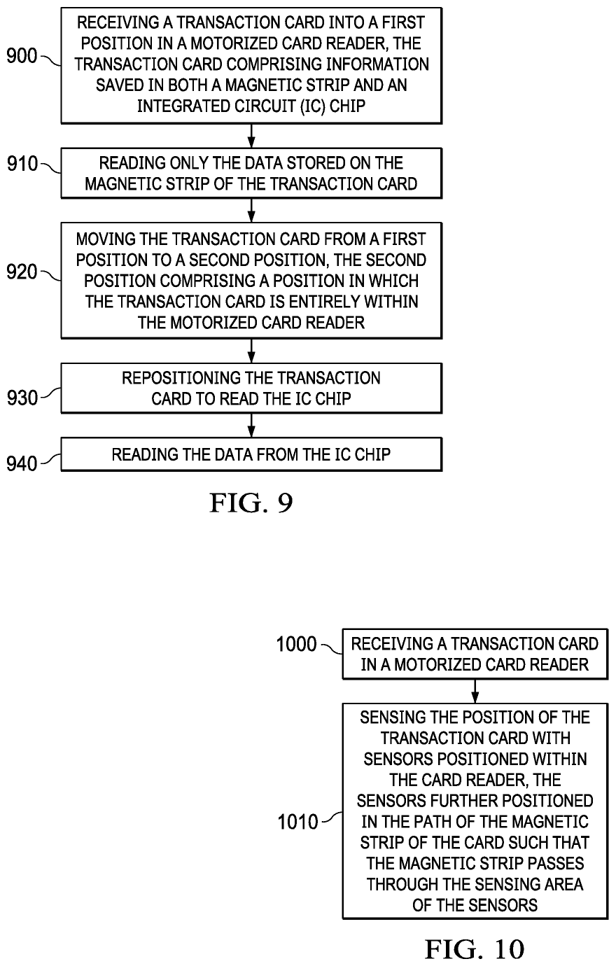

FIG. 9 provides a flow diagram of an example embodiment of a method of card reader protection. In block 900, a transaction card is received into a first position in a motorized card reader, the transaction card comprising information saved in both a magnetic strip and an integrated circuit (IC) chip. In block 910, only the data stored on the magnetic strip of the transaction card is read. In block 920, the transaction card is moved from a first position to a second position, the second position comprising a position in which the transaction card is entirely within the motorized card reader. In block 930, the transaction card is repositioned to read the IC chip. In block 940, the data from the IC chip is read.

FIG. 10 provides a flow diagram of an example embodiment of a method of card reader protection. In block 1000, a transaction card is received in a motorized card reader. In block 1010, the position of the transaction card is sensed with sensors positioned within the card reader, the sensors further positioned in the path of the magnetic strip of the card such that the magnetic strip passes through the sensing area of the sensors.

Representative claim sets include:

Claim set A

A1. A system comprising: a motorized card reader, the card reader configured to read information saved in at least one of a magnetic strip and an integrated circuit (IC) chip of a card inserted into the card reader; and

a protection system comprised of a plurality of printed circuit boards (PCBs), at least two of the plurality of PCBs mechanically connected with slot joints, the at least two of the plurality of PCBs comprising multiple layers with maze-shaped serpentine circuit traces that comprise via-holes at the slot joint portion of the at least two of the plurality of PCBs.

A2. The system of claim 1, wherein the protection system is compliant with payment card industry (PCI) protection standards.

A3. The system of claim 1, wherein the protection system PCBs enclose a main PCB of the motorized card reader such that an inserted card cannot be physically accessed while the card is in the reader.

A4. The system of claim 1, wherein at least one of the protection system PCBs comprises an open switch in the serpentine traces is closed with a conductive rubber device.

A5. The system of claim 1, wherein the via-holes of at least one of the plurality of protection system PCBs are configured to be hidden in an overlapped area formed in the slot joint with a second of the plurality of protection system PCBs.

A6. The system of claim 1, further comprising sensors positioned within the card reader, the sensors positioned in the path of the magnetic strip of the card such that the magnetic strip passes through the sensing area of the sensors.

A7. The system of claim 1, wherein the card reader is configured to operate in a two stage configuration comprising a first insertion stage of the card and a second adjustment stage of the card, the first insertion stage comprising reading only data saved in the magnetic strip of the card, the second adjustment stage comprising reading only data saved in the IC chip of the card.

A8. The system of claim 7, wherein the second adjustment stage begins a partial ejection of the card, in which the card remains unexposed to a card owner and a repositioning to read the IC chip on the card.

A9. A method, comprising: presenting a motorized card reader, the card reader configured to read information saved in at least one of a magnetic strip and an integrated circuit (IC) chip of a card inserted into the card reader; and providing a protection system comprised of a plurality of printed circuit boards (PCBs), at least two of the plurality of PCBs mechanically connected with slot joints, the at least two of the plurality of PCBs comprising multiple layers with maze-shaped serpentine circuit traces that comprise via-holes at the slot joint portion of the at least two of the plurality of PCBs.

A10. The method of claim 9, further comprising closing an open switch in the serpentine traces with a conductive rubber device. A11. The method of claim 9, wherein providing the protection system comprises enclosing the card reader such that the card may not be physically accessed while the card is inside the reader.

A12. The method of claim 9, wherein providing the protection system comprises providing the protection system in compliance with payment card industry (PCI) protection standards.

A13. The method of claim 9, wherein the via-holes of at least one of the plurality of protection PCBs are configured to be hidden in an overlapped area formed in the slot joint with a second of the plurality of PCBs.

A14. The method of claim 9, further comprising:

receiving a payment card with a motorized card reader in a first stage, the payment card comprising at least one of a magnetic strip and an integrated circuit (IC) chip, the strip and the chip configured to save data;

reading data from the magnetic strip;

receiving the payment card at an IC chip card reader with the motorized card reader in a second stage; and

reading data saved in the IC chip during the second stage.

A15. The method of claim 15, further comprising:

executing a payment process;

sending payment data to a terminal device;

ejecting the payment card.

A16. A system comprising:

a protection system for a motorized card reader comprised of a plurality of printed circuit boards (PCBs), at least two of the plurality of PCBs mechanically connected with slot joints, the at least two of the plurality of PCBs comprising multiple layers with maze-shaped serpentine circuit traces that comprise via-holes at the slot joint portion of the at least two of the plurality of PCBs.

A17. The system of claim 16, wherein the protection system is compliant with payment card industry (PCI) protection standards.

A18. The system of claim 16, wherein the via-holes of at least one of the plurality of protection system PCBs are configured to be hidden in an overlapped area formed in the slot joint with a second of the plurality of protection system PCBs.

A19. The system of claim 16, further comprising sensors positioned within the card reader, the sensors positioned in the path of the magnetic strip of the card such that the magnetic strip passes through the sensing area of the sensors.

A20. The system of claim 19, wherein the sensors comprise at least one of optical, infrared, proximity, ultrasonic, and magnetic sensors.

SET B—PCBs connected with slot joints

B1. A system comprising:

a motorized card reader, the card reader configured to read information saved in at least one of a magnetic strip and an integrated circuit (IC) chip of a card inserted into the card reader; and

a protection system comprised of a plurality of printed circuit boards (PCBs), the PCBs mechanically connected with slot joints.

B2. The system of claim 1, wherein the at least two of the plurality of PCBs comprise multiple layers with maze-shaped serpentine circuit traces that comprise via-holes at the slot joint portion of the at least two of the plurality of PCBs.

B3. The system of claim 2, wherein the via-holes of at least one of the plurality of protection system PCBs are configured to be hidden in an overlapped area formed in the slot joint with a second of the plurality of protection system PCBs.

B4. The system of claim 2, wherein at least one of the serpentine circuit traces comprises an open switch such that when it is in place against a main or sub PCB of the motorized card reader, the open switch is closed with a conductive rubber device.

B5. The system of claim 1, wherein the protection system is compliant with payment card industry (PCI) protection standards.

B6. The system of claim 1, further comprising sensors positioned within the card reader, the sensors positioned in the path of the magnetic strip of the card such that the magnetic strip passes through the sensing area of the sensors.

B7. The system of claim 6, wherein the sensors comprise at least one of optical, infrared, proximity, ultrasonic, and magnetic sensors

B8. The system of claim 1, wherein the card reader is configured to operate in a two stage configuration comprising a first insertion stage of the card and a second re-engaging stage of the card, the first stage comprising reading only data saved in the magnetic strip of the card, the second stage comprising reading only data saved in the IC chip of the card.

B9. A method comprising:

providing a motorized card reader, the card reader configured to read information saved in at least one of a magnetic strip and an integrated circuit (IC) chip of a card inserted into the card reader; and

protecting the motorized card reader by providing a plurality of printed circuit boards (PCBs), the PCBs mechanically connected with slot joints.

B10. The method of claim 9, wherein providing the protection system further comprises providing at least two of the plurality of PCBs comprise multiple layers with maze-shaped serpentine circuit traces that comprise via-holes at the slot joint portion of the at least two of the plurality of PCBs.

B11. The method of claim 10, further comprising hiding the via-holes of at least one of the plurality of protection system PCBs in an overlapped area formed in the slot joint with a second of the plurality of protection system PCBs.

B12. The method of claim 9, wherein the protecting is compliant with payment card industry (PCI) protection standards.

B13. The method of claim 9, wherein the protecting comprises enclosing a main PCB of the motorized card reader such that an inserted card cannot be physically accessed while the card is in the reader.

B14. The method of claim 9, further comprising:

receiving a payment card with the motorized card reader in a first stage, the payment card comprising at least one of a magnetic strip and an integrated circuit (IC) chip, the strip and the chip configured to save data; reading data from the magnetic strip;

receiving the payment card at an IC chip card reader with the motorized card reader in a second stage; and

reading data saved in the IC chip during the second stage.

B15. The method of claim 14, further comprising:

executing a payment process;

sending payment data to a terminal device;

ejecting the payment card.

B16. A motorized card reader protection system comprising: a plurality of printed circuit boards (PCBs), the PCBs mechanically connected with slot joints the PCBs surrounding a main PCB of the motorized card reader.

B17. The system of claim 16, wherein the protection system is compliant with payment card industry (PCI) protection standards.

B18. The system of claim 16, wherein at least two of the plurality of PCBs comprise multiple layers with maze-shaped serpentine circuit traces that comprise via-holes at the slot joint portion of the at least two of the plurality of PCBs.

B19. The system of claim 18, wherein the via-holes of at least one of the plurality of protection system PCBs are configured to be hidden in an overlapped area formed in the slot joint with a second of the plurality of protection system PCBs.

B20, The system of claim 18, wherein at least one of the serpentine circuit traces comprises an open switch such that when it is in place against a main or sub PCB of the motorized card reader, the open switch is closed with a conductive rubber device.

SET C—two stage card reading

C1. A system comprising:

a motorized card reader, the card reader configured to read information saved in at least one of a magnetic strip and an integrated circuit (IC) chip of a card inserted into the card reader, the card reader configured to operate in a two stage configuration comprising a first insertion stage of the card and a second IC chip reading stage, the first stage comprising reading only data saved in the magnetic strip of the card, the second stage comprising reading only data saved in the IC chip of the card.

C2. The system of claim 1, wherein the motorized card reader is further configured to:

execute a payment process;

send payment data to a terminal device; and

eject the card.

C3. The system of claim 1, further comprising a protection system comprised of a plurality of printed circuit boards (PCBs), the PCBs mechanically connected with slot joints.

C4. The system of claim 3, wherein at least two of the plurality of PCBs comprise multiple layers with maze-shaped serpentine circuit traces that comprise via-holes at the slot joint portion of the at least two of the plurality of PCBs.

C5. The system of claim 4, wherein the via-holes of at least one of the plurality of protection system PCBs are configured to be hidden in an overlapped area formed in the slot joint with a second of the plurality of protection system PCBs.

C6. The system of claim 3, wherein at least one of the serpentine circuit traces comprises an open switch such that when it is in place against a main or sub PCB of the motorized card reader, the open switch is closed with a conductive rubber device.

C7. The system of claim 3, wherein the protection system is compliant with payment card industry (PCI) protection standards.

C8. The system of claim 1, further comprising sensors positioned within the card reader, the sensors positioned in the path of the magnetic strip of the card such that the magnetic strip passes through the sensing area of the sensors.

C9. The system of claim 8, wherein the sensors comprise at least one of optical, infrared, proximity, ultrasonic, and magnetic sensors.

C10. A method comprising:

receiving a transaction card into a first position in a motorized card reader, the transaction card comprising information saved in both a magnetic strip and an integrated circuit (IC) chip;

reading only the data stored on the magnetic strip of the transaction card;

moving the transaction card from a first position to a second position, the second position comprising a position in which the transaction card is entirely within the motorized card reader;

repositioning the transaction card to read the IC chip; and reading the data from the IC chip.

C11. The method of claim 10, further comprising: executing a payment process; sending payment data to a terminal device; and ejecting the transaction card.

C12. The method of claim 10, further comprising protecting a main printed circuit board (PCB) of the motorized card reader with a plurality of protection PCBs, the protection PCBs mechanically connected with slot joints.

C13. The method of claim 12, wherein at least two of the plurality of PCBs comprise multiple layers with maze-shaped serpentine circuit traces that comprise via-holes at the slot joint portion of the at least two of the plurality of PCBs.

C14. The method of claim 13, wherein the via-holes of at least one of the plurality of protection system PCBs are configured to be hidden in an overlapped area formed in the slot joint with a second of the plurality of protection system PCBs.

C15. The method of claim 13, wherein at least one of the serpentine circuit traces comprises an open switch such that when it is in place against a main or sub PCB of the motorized card reader, the open switch is closed with a conductive rubber device.

C16. The system of claim 12, wherein the protecting of the main PCB complies with payment card industry (PCI) protection standards.

C17 A tangible computer readable medium comprising software, the software comprising instructions for:

receiving a transaction card into a first position in a motorized card reader, the transaction card comprising information saved in both a magnetic strip and an integrated circuit (IC) chip;

reading only the data stored on the magnetic strip of the transaction card;

moving the transaction card from a first position to a second position, the second position comprising a position in which the transaction card is entirely within the motorized card reader;

repositioning the transaction card to read the IC chip; and

reading the data from the IC chip.

C18. The computer readable medium of claim 17, further comprising instructions for:

executing a payment process;

sending payment data to a terminal device; and

ejecting the transaction card.

C19. The computer readable medium of claim 17, further comprising instructions for sensing the position of the transaction card with sensors positioned in the pathway of the magnetic strip.

C20. The computer readable medium of claim 17, wherein the sensors comprise at least one of optical, infrared, proximity, ultrasonic, and magnetic sensors.

SET D—light sensor positioning

D1. A system comprising:

a motorized card reader, the card reader configured to read information saved in at least one of a magnetic strip and an integrated circuit (IC) chip of a card inserted into the card reader; and

sensors positioned within the card reader, the sensors further positioned in the path of the magnetic strip of the card such that the magnetic strip passes through the sensing area of the sensors.

D2. The system of claim 1, wherein the sensors comprise at least one of optical, infrared, proximity, ultrasonic, and magnetic sensors.

D3. The system of claim 1, further comprising a protection system comprised of a plurality of printed circuit boards (PCBs), at least two of the plurality of PCBs mechanically connected with slot joints, the at least two of the plurality of PCBs comprising multiple layers with maze-shaped serpentine circuit traces that comprise via-holes at the slot joint portion of the at least two of the plurality of PCBs.

D4. The system of claim 1, wherein the protection system is compliant with payment card industry (PCI) protection standards.

D5. The system of claim 1, wherein the protection system PCBs enclose a main PCB of the motorized card reader such that an inserted card cannot be physically accessed while the card is in the reader.

D6. The system of claim 1, wherein at least one of the protection system PCBs is connected to a main PCB with conductive rubber devices.

D7. The system of claim 1, wherein the via-holes of at least one of the plurality of protection system PCBs are configured to be hidden in an overlapped area formed in the slot joint with a second of the plurality of protection system PCBs.

D8. The system of claim 1, wherein the card reader is configured to operate in a two stage configuration comprising a first insertion stage of the card and a second adjustment stage of the card, the first insertion stage comprising reading only data saved in the magnetic strip of the card, the second adjustment stage comprising reading only data saved in the IC chip of the card.

D9. The system of claim 8, wherein the second adjustment stage begins a partial ejection of the card, in which the card remains unexposed to a card owner and a repositioning to read the IC chip on the card.

D10. A method comprising:

receiving a transaction card in a motorized card reader; and.

sensing the position of the transaction card with sensors positioned within the card reader, the sensors further positioned in the path of the magnetic strip of the card such that the magnetic strip passes through the sensing area of the sensors.

D11. The method of claim 10, wherein the sensors comprise at least one of optical, infrared, proximity, ultrasonic, and magnetic sensors.

D12. The method of claim 10, further comprising:

receiving the transaction card into a first position in a motorized card reader, the transaction card comprising information saved in both a magnetic strip and an integrated circuit (IC) chip;

reading only the data stored on the magnetic strip of the transaction card;

moving the transaction card from a first position to a second position, the second position comprising a position in which the transaction card is entirely within the motorized card reader;

repositioning the transaction card to read the IC chip; and

reading the data from the IC chip.

D13. The method of claim 12, further comprising:

executing a payment process;

sending payment data to a terminal device; and

ejecting the transaction card.

D14. The method of claim 10, further comprising:

protecting a main printed circuit board (PCB) of the motorized card reader with a plurality of protection PCBs, the protection PCBs mechanically connected with slot joints.

D15. The method of claim 14, wherein the protecting of the main PCB complies with payment card industry (PCI) protection standards.

D16, A tangible computer readable medium comprising software, the software comprising instructions for:

receiving a transaction card in a motorized card reader; and.

sensing the position of the transaction card with sensors positioned within the card reader, the sensors further positioned in the path of the magnetic strip of the card such that the magnetic strip passes through the sensing area of the sensors.

D17. The computer readable medium of claim, further comprising instructions for:

receiving the transaction card into a first position in a motorized card reader, the transaction card comprising information saved in both a magnetic strip and an integrated circuit (IC) chip;

reading only the data stored on the magnetic strip of the transaction card.

D18. The computer readable medium of claim 16, wherein the sensors comprise at least one of optical, infrared, proximity, ultrasonic, and magnetic sensors.

D19. The computer readable medium of claim 16, further comprising instructions for:

executing a payment process;

sending payment data to a terminal device; and

ejecting the transaction card

D20. The computer readable medium of claim 16, further comprising protecting a main printed circuit board (PCB) of the motorized card reader with a plurality of protection PCBs, the protection PCBs mechanically connected with slot joints.

SET E—conductive rubber

E1. A system comprising:

a motorized card reader, the card reader configured to read information saved in at least one of a magnetic strip and an integrated circuit (IC) chip of a card inserted into the card reader; and

a protection system comprised of a plurality of printed circuit boards (PCBs) the PCBs electrically connected with a conductive rubber device.

E2. The system of claim 1, wherein the conductive rubber device is configured at an open switch connection of a protection PCB.

E3. The system of claim 1, wherein the protection system is compliant with payment card industry (PCI) protection standards.

E4. The system of claim 1, wherein the PCBs enclose the card reader such that the card may not be physically accessed while the card is inside the card reader.

E5. The system of claim 1, wherein the PCBs are mechanically connected with slot joints

E6. The system of claim 5, wherein the PCBs comprise multiple layers with maze-shaped serpentine circuit traces that comprise via-holes in a middle layer at the slot joint portion of the PCB.

E7. The system of claim 6, wherein the via-holes of at least one of the plurality of PCBs are configured to be hidden in the overlapped area formed in the slot joint with a second of the plurality of PCBs.

E8 The system of claim 1, further comprising sensors positioned within the card reader, the sensors further positioned in the path of the magnetic strip of the card such that the magnetic strip passes through the sensing area of the sensors.

E9. The system of claim 8, wherein the sensors comprise at least one of optical, infrared, proximity, ultrasonic, and magnetic sensors.

E10. The system of claim 1, wherein the card reader is configured to operate in a two stage configuration comprising a first insertion stage of the card and a second adjustment stage of the card, the first insertion stage comprising reading only data saved in the magnetic strip of the card, the second adjustment stage comprising reading only data saved in the IC chip of the card.

E11. The system of claim 8, wherein the second adjustment stage begins a partial ejection of the card, in which the card remains unexposed to a card owner and a repositioning to read the IC chip on the card

E12. A method comprising:

receiving a payment card with a motorized card reader in a first stage, the payment card comprising at least one of a magnetic strip and an integrated circuit (IC) chip, the strip and the chip configured to save data, the motorized card reader configured to be compliant with payment card industry (PCI) protection standards;

detecting the presence of the card with light sensors positioned within the card reader, the light sensors further positioned in the path of the magnetic strip of the card such that the magnetic strip passes through the sensing area of the light sensors;

reading data saved in the magnetic strip during the first stage;

ejecting the payment card from the motorized card reader;

receiving the payment card with the motorized card reader in a second stage; and

reading data saved in the IC chip during the second stage.

E13. The method of claim 12, wherein the motorized card reader employs a protection system to meet the PCI protection standards.

E14. The method of claim 13, wherein the protection system comprises a plurality of printed circuit boards (PCBs) the PCBs electrically connected with a conductive rubber device.

E15. The method of claim 13, wherein the protection system comprises a plurality of printed circuit boards (PCBs), the PCBs mechanically connected with slot joints.

E16. The method of claim 12, further comprising: executing a payment process;

sending payment data to a terminal device; and

ejecting the payment card.

E17. A tangible computer readable medium comprising software, the software comprising instructions for:

receiving a payment card with a motorized card reader in a first stage, the payment card comprising at least one of a magnetic strip and an integrated circuit (IC) chip, the strip and the chip configured to save data, the motorized card reader configured to be compliant with payment card industry (PCI) protection standards;

detecting the presence of the card with light sensors positioned within the card reader, the light sensors further positioned in the path of the magnetic strip of the card such that the magnetic strip passes through the sensing area of the light sensors;

reading data saved in the magnetic strip during the first stage;

ejecting the payment card from the motorized card reader; receiving the payment card with the motorized card reader in a second stage; and

reading data saved in the IC chip during the second stage.

The flow charts of FIGS. 2 and 7-10 show the architecture, functionality, and operation of a possible implementation of card reader protection. In this regard, each block represents a module, segment, or portion of code, which comprises one or more executable instructions for implementing the specified logical function(s). It should also be noted that in some alternative implementations, the functions noted in the blocks may occur out of the order noted in FIGS. 2 and 7-10. For example, two blocks shown in succession in FIGS. 2 and 7-10 may in fact be executed substantially concurrently or the blocks may sometimes be executed in the reverse order, depending upon the functionality involved. Any process descriptions or blocks in flow charts should be understood as representing modules, segments, or portions of code which include one or more executable instructions for implementing specific logical functions or steps in the process, and alternate implementations are included within the scope of the example embodiments in which functions may be executed out of order from that shown or discussed, including substantially concurrently or in reverse order, depending on the functionality involved. In addition, the process descriptions or blocks in flow charts should be understood as representing decisions made by a hardware structure such as a state machine.

The logic of the example embodiment(s) can be implemented in hardware, software, firmware, or a combination thereof. In example embodiments, the logic is implemented in software or firmware that is stored in a memory and that is executed by a suitable instruction execution system. If implemented in hardware, as in an alternative embodiment, the logic can be implemented with any or a combination of the following technologies, which are all well known in the art: a discrete logic circuit(s) having logic gates for implementing logic functions upon data signals, an application specific integrated circuit (ASIC) having appropriate combinational logic gates, a programmable gate array(s) (PGA), a field programmable gate array (FPGA), etc. In addition, the scope of the present disclosure includes embodying the functionality of the example embodiments disclosed herein in logic embodied in hardware or software-configured mediums.

Software embodiments, which comprise an ordered listing of executable instructions for implementing logical functions, can be embodied in any computer-readable medium for use by or in connection with an instruction execution system, apparatus, or device, such as a computer-based system, processor-containing system, or other system that can fetch the instructions from the instruction execution system, apparatus, or device and execute the instructions. In the context of this document, a “computer-readable medium” can be any means that can contain, store, or communicate the program for use by or in connection with the instruction execution system, apparatus, or device. The computer readable medium can be, for example but not limited to, an electronic, magnetic, optical, electromagnetic, infrared, or semiconductor system, apparatus, or device. More specific examples (a nonexhaustive list) of the computer-readable medium would include the following: a portable computer diskette (magnetic), a random access memory (RAM) (electronic), a read-only memory (ROM) (electronic), an erasable programmable read-only memory (EPROM or Flash memory) (electronic), and a portable compact disc read-only memory (CDROM) (optical). In addition, the scope of the present disclosure includes embodying the functionality of the example embodiments of the present disclosure in logic embodied in hardware or software-configured mediums.

It should be emphasized that the above-described embodiments of the present disclosure, particularly, any “preferred” embodiments, are merely possible examples of implementations, merely set forth for a clear understanding of the principles of the disclosure. Many variations and modifications may be made to the above-described embodiment(s) of the disclosure without departing substantially from the spirit and principles of the disclosure. All such modifications and variations are intended to be included herein within the scope of this disclosure and the present disclosure and protected by the following claims.

Therefore, at least the following is claimed:

1. A system comprising:
a motorized card reader, the card reader configured to read information saved in at least one of a magnetic strip and an integrated circuit (IC) chip of a card inserted into the card reader; and
a protection system comprised of a plurality of printed circuit boards (PCBs), at least two of the plurality of PCBs mechanically connected with slot joints, the at least two of the plurality of PCBs comprising multiple layers with maze-shaped serpentine circuit traces that comprise via-holes at the slot joint portion of the at least two of the plurality of PCBs.

2. The system of claim 1, wherein the protection system is compliant with payment card industry (PCI) protection standards.

3. The system of claim 1, wherein the protection system PCBs enclose a main PCB of the motorized card reader such that an inserted card cannot be physically accessed while the card is in the reader.

4. The system of claim 1, wherein at least one of the protection system PCBs comprises an open switch in the serpentine traces is closed with a conductive rubber device.

5. The system of claim 1, wherein the via-holes of at least one of the plurality of protection system PCBs are configured to be hidden in an overlapped area formed in the slot joint with a second of the plurality of protection system PCBs.

6. The system of claim 1, further comprising sensors positioned within the card reader, the sensors positioned in the path of the magnetic strip of the card such that the magnetic strip passes through the sensing area of the sensors.

7. The system of claim 1, wherein the card reader is configured to operate in a two stage configuration comprising a first insertion stage of the card and a second adjustment stage of the card, the first insertion stage comprising reading only data saved in the magnetic strip of the card, the second adjustment stage comprising reading only data saved in the IC chip of the card.

8. The system of claim 7, wherein the second adjustment stage begins a partial ejection of the card, in which the card remains unexposed to a card owner and a repositioning to read the IC chip on the card.

9. A method, comprising:
providing a motorized card reader, the card reader configured to read information saved in at least one of a magnetic strip and an integrated circuit (IC) chip of a card inserted into the card reader; and
providing a protection system comprised of a plurality of printed circuit boards (PCBs), at least two of the plurality of PCBs mechanically connected with slot joints, the at least two of the plurality of PCBs comprising multiple layers with maze-shaped serpentine circuit traces that comprise via-holes at the slot joint portion of the at least two of the plurality of PCBs.

10. The method of claim 9, further comprising closing an open switch in the serpentine traces with a conductive rubber device.

11. The method of claim 9, wherein providing the protection system comprises enclosing the card reader such that the card may not be physically accessed while the card is inside the reader.

12. The method of claim 9, wherein providing the protection system comprises providing the protection system in compliance with payment card industry (PCI) protection standards.

13. The method of claim 9, wherein the via-holes of at least one of the plurality of protection PCBs are configured to be hidden in an overlapped area formed in the slot joint with a second of the plurality of PCBs.

14. The method of claim 9, further comprising:
receiving a payment card with a motorized card reader in a first stage, the payment card comprising at least one of a magnetic strip and an integrated circuit (IC) chip, the strip and the chip configured to save data;
reading data from the magnetic strip;
receiving the payment card at an IC chip card reader with the motorized card reader in a second stage; and
reading data saved in the IC chip during the second stage.

15. The method of claim 15, further comprising:
executing a payment process;
sending payment data to a terminal device;
ejecting the payment card.

16. A system comprising:
a protection system for a motorized card reader comprised of a plurality of printed circuit boards (PCBs), at least two of the plurality of PCBs mechanically connected with slot joints, the at least two of the plurality of PCBs comprising multiple layers with maze-shaped serpentine circuit traces that comprise via-holes at the slot joint portion of the at least two of the plurality of PCBs.

17. The system of claim 16, wherein the protection system is compliant with payment card industry (PCI) protection standards.

18. The system of claim 16, wherein the via-holes of at least one of the plurality of protection system PCBs are configured to be hidden in an overlapped area formed in the slot joint with a second of the plurality of protection system PCBs.

19. The system of claim 16, further comprising sensors positioned within the card reader, the sensors positioned in the path of the magnetic strip of the card such that the magnetic strip passes through the sensing area of the sensors.

20. The system of claim 19, wherein the sensors comprise at least one of optical, infrared, proximity, ultrasonic, and magnetic sensors.
